(19) United States
(12) Patent Application Publication
(10) Pub. No.: US 2010/0077085 A1
(43) Pub. Date: Mar. 25, 2010

(54) Systems and method for configuring display resolution in a terminal server environment

(76) Inventor: Joseph Chyam Cohen, Burbank, CA (US)

Correspondence Address: Albert R. Ubieta;Torrey Pines Intellectual Property Group, P.C., 2658 Del Mar Heights Road, No. 431, Del Mar, CA, 92014, US

(21) Appl. No.: 12/586,615

(22) Filed: Sep. 23, 2009

Related U.S. Application Data
(60) Provisional application No. 61/099,497, filed on Sep. 23, 2008.

(51) Int. Cl. G06F 3/01; G06F 15/16

(52) U.S. Cl. 709/227; 715/744

(57) ABSTRACT

Methods, apparatus, systems and computer program product for configuring display resolution in a terminal server environment. A host system can receive a request for a graphical session, wherein the request identifies a non-standard resolution and the host system generates display initialization information for the non-standard resolution prior to transmitting graphic information to the remote client. The host system can configure a virtual monitor in the non-standard resolution, retain the display initialization information for the non-standard resolution, and can pre-render future graphical sessions in that resolution. Additionally, the host system can maintain a graphical session during a period of inactivity without terminating and, upon reconnection of the remote client, determine if the session should be maintained in the original display resolution or configured for a new resolution.

### CROSS-REFERENCE TO RELATED APPLICATIONS

This application claims the benefit of provisional patent application Ser. No. 61/099,497, filed Sep. 23, 2008, which is incorporated by reference.

### FEDERALLY SPONSORED RESEARCH

Not applicable.

### SEQUENCE LISTING OR PROGRAM

Not applicable.

### FIELD OF THE INVENTION

The present invention relates to the field of computer networks. In particular, the present invention relates to methods, apparatus, systems and computer program product for configuring display resolution in a terminal server environment.

### BACKGROUND

For enterprises large and small, consolidation of hardware and software is increasingly vital due to reasons of accessibility, reliability, data security, cost and the administration of applications and the network itself. Managing remote users, their computing experience and their access to networks is similarly crucial. Many different types of institutions have used terminal server applications to provide a computing environment and to address these issues, despite having varied institutional and computing objectives. For instance, educational institutions deploy computer networks to allow teachers, students and staff to connect remotely, thereby allowing increased productivity, easier access to information, rapid communication and, ultimately, enhanced learning opportunities. Government agencies are perhaps more concerned with data security, which is why terminal services always have been essential to their information technology infrastructures. Thin client and network deployments have been mandated in several agencies—this allows all operations to be performed centrally, and secures and monitors information that may have been sent or received. Commercial organizations, as well, benefit from deploying terminal servers so that data transmission can be managed and controlled; for example, by requiring users to access data through smart cards and biometrics, and allowing editing and review of the data only within a secure environment, or by certain identified users. And in the case of organizations of all types there is a growing need for network users to access information via mobile or handheld devices from remote locations.

Centralized computing results in cost savings, ease of administration and enhanced security. Since almost all the processing of an application is done on a central server, companies are not forced to continuously upgrade or replace client or user hardware to keep pace with the systems requirements of modern applications. Maintenance of applications is isolated to the application server and not each individual node, also reducing administrative overhead. Servers are usually located in secure data centers, reducing the risk of physical theft. Centralized malware and audit processes also facilitate enhanced security. In addition, replacing workstations with thin clients can reduce energy consumption, environmental costs, support cost, and hardware costs.

Despite these advantages, contemporary network protocols often suffer from drawbacks in that they are not optimized to provide a properly-rendered graphical interface across the multitude of end-user platforms accessing the network. Oftentimes, a remote device connecting to a terminal server has a different screen size than the terminal server's screen size, and also different from the screen sizes of other connected remote devices. Certain graphical operating system environments, however, are not capable of handling the dynamic display changes needed in a multi-user environment. For this reason, a need exists for improved graphics configuration methods that allow multiple remote devices, with displays of differing resolutions, to independently receive proper graphical output from a single network server.

### SUMMARY

The disclosed embodiments relate to methods, apparatus, systems and computer program product for configuring display resolution in a terminal server environment. In accordance with a preferred embodiment, the disclosed methods, apparatus, systems and computer program product provide for configuration of display resolution for non-standard resolutions in a terminal server environment. In certain embodiments, a host system receives a request for a graphical session, wherein the request identifies a non-standard resolution (or a resolution not yet supported by the host system), and the host system generates display initialization information for the non-standard resolution prior to transmitting graphic information to the remote client. In one preferred embodiment, the host system configures a virtual monitor in the non-standard resolution. In other preferred embodiments, the host system retains the display initialization information for the non-standard resolution and is capable of pre-rendering future graphical sessions in that resolution. In a preferred embodiment, the host system will maintain a graphical session without termination, despite a period of inactivity, and upon reconnect of the remote client determine if the session should be maintained in the original display resolution or configured for a new resolution. By storing in memory the newly-added non-standard display resolutions, the host system is able to provide pre-rendered graphics interfaces to subsequent remote clients reporting non-standard resolutions. Thus, among the advantages disclosed herein, one or more aspects are to provide server support for non-standard resolutions and displays during a terminal server session, resulting in faster and more robust communications.

### DRAWINGS

The accompanying drawings, which are incorporated in and constitute a part of this specification, illustrate embodiments of the invention and together with the description serve to explain the principles of the invention.

FIG. 1 graphically depicts an exemplary computer network with architectural elements corresponding to graphical output of user sessions.

FIG. 2 is a flow chart of an exemplary process for initializing a new graphical session associated with a remote client.

FIG. 3 is a flow chart of an exemplary process for reconnecting to an established graphical session.

### DETAILED DESCRIPTION

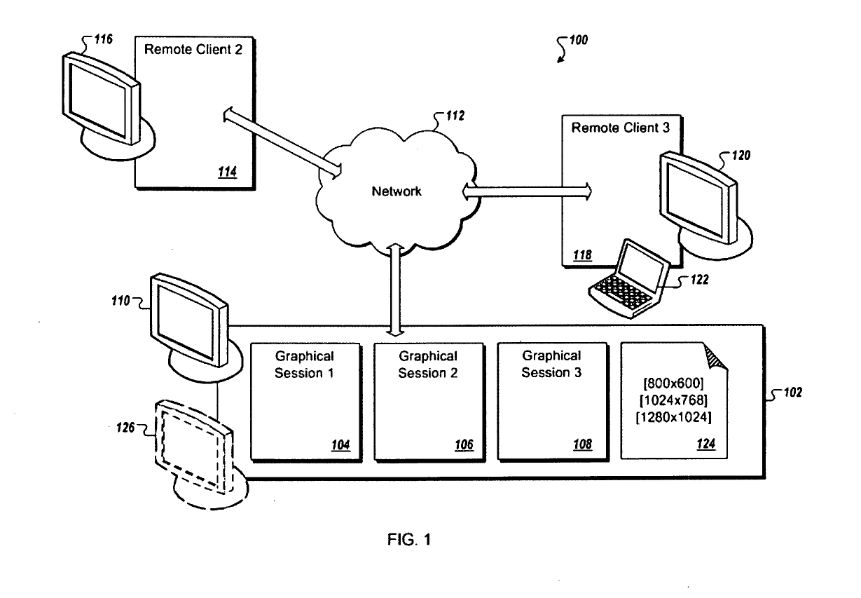

FIG. 1 shows an example computer network 100, which can include architectural elements corresponding to at least one output of a user graphical session (or context). The computer network 100 can include a host system 102. One or more graphical sessions, such as graphical sessions 104, 106, and 108, can be hosted on the host system 102. Further, the host system 102 can include a monitor 110 and a list of standard supported resolutions 124. The computer network 100 also can include one or more remote clients, such as a first remote client 114 and a second remote client 118. The first remote client 114 can include a monitor 116. The second remote client 118 can include monitors 120 and 122. The host system 102 and the remote clients can communicate over a shared network 112, which can be a public network, e.g. the Internet, a private network, e.g. a Local Area Network (LAN), or a combination thereof.

The first remote client 114 and the second remote client 118 can be any computing system configurable to communicate over the shared network 112, such as a desktop computer, a laptop computer, a palm top computer, a server, a workstation, a mobile communications device, and an embedded computing system. The remote clients can be configured to provide output through one or more displays, such as the monitors 116, 120, and/or 122. Further, the first remote client 114 and the second remote client 118 can be configured to communicate with the shared network 112 through a wired or wireless connection.

The host system 102 can be any computing system, such as a desktop computer, a laptop computer, a palm top computer, a server, a workstation, a mobile communications device, and an embedded computing system, that is configurable to host a plurality of graphical sessions, including one or more remote graphical sessions. In some implementations, the host system 102 can act as a server for one or more remote clients, such as the first remote client 114 and the second remote client 118. Further, the host system 102 can be separated from a remote client, such as the remote clients 114 and 118, by any distance. For example, a remote client can be a desktop computer located at an employee's home and the host system 102 can be a server located at a corresponding employer's site.

A graphical session, which in some implementations can be referred to as a user session or a context, can be configured as a single environment in which a user can access one or more operating system functions. In some implementations, each graphical session, such as the graphical sessions 104, 106 and 108 executing in the host system 102, is kept separate from all other graphical sessions. For example, separate memory utilization, file system access, and/or process execution can be maintained for each graphical session. In this way, actions and/or functions associated with one graphical session can be isolated to reduce their impact on one or more other existing graphical sessions as well as the host operating system. It will be appreciated that some actions taken in one graphical session can affect one or more other graphical sessions. For example, use of system resources by one graphical session can directly or indirectly reduce the system resources available to one or more other graphical sessions. In another example, a graphical session can be given special privileges to monitor or interact with one or more other graphical sessions, such as for maintenance purposes.

A graphical session can be associated with a particular display. For example, the graphical session 104 can be associated with the monitor 110 and the graphical session 106 can be associated with the monitor 116 of the first remote client 114. A display, such as the monitors 110, 116, 120, and/or 122, can be any device configured to display output, such as a cathode ray tube (CRT) monitor, a light emitting diode (LED) monitor, a television, a liquid crystal display (LCD), or a projector. For example, the monitor 110 can present output generated in association with the graphical session 104. Because the host system 102 includes both the monitor 110 and the graphical session 104, the monitor 110 is a local monitor. The graphical session 106 can be associated with the first remote client 114, which includes the monitor 116. Thus, data representative of the graphical session 106 can be transmitted by the host system 102 over the shared network 112 to the first remote client 114. The first remote client 114 can then display the output information on the monitor 116.

A graphical session also can be associated with a system having more than one monitor. For example, the graphical session 108 is associated with the second remote client 118, which includes the monitors 120 and 122. Data representative of the graphical session 108 can be transmitted over the shared network 112 to the second remote client 118. The second remote client 118 can display the output information on either or both of the monitors 120 and 122. For example, the monitors 120 and 122 can be configured such that one or both of the monitors displays at least a portion of the output corresponding to the graphical session 108. Alternatively, the monitors 120 and 122 each can be configured to display data representative of the graphical session 108 (or cloned).

Additionally, the host system 102 can configure a virtual monitor 126 that can have any properties associated with one or more physical monitors. The virtual monitor 126 can be realized as a software object. In some implementations, the virtual monitor 126 can be a software driver that is created by modifying portions of a driver used to display output data. In some other implementations, the virtual monitor 126 can be a software driver that is created as a subclass of a video driver. For example, the virtual monitor can function like a video driver that does not update an output buffer. The virtual monitor 126 can be configured to operate at a desired resolution so that the graphics processing of the host system 102 can scan the virtual monitor 126 and use the information obtained to generate support for that resolution.

The list of standard supported resolutions 124 can correspond to display resolutions generally supported by most available monitors. For example, the list of standard supported resolutions 124 can include 800 pixels by 600 pixels, 1024 pixels by 768 pixels, and 1280 pixels by 1024 pixels. In some implementations, one or more additional resolutions can be added to the list of standard supported resolutions 124 and one or more included resolutions can be deleted from the list of standard supported resolutions 124. For example, if multiple clients interfacing with the host system 102 support a common resolution, that resolution can be added to the list of standard supported resolutions 124. Additionally, a custom resolution being utilized by a remote client can be added to the list of standard supported resolutions 124 for use in pre-rendering display information for a graphical session that is being initialized.

In some implementations, the host system 102 can be configured to perform one or more actions to pre-initialize (or pre-render) display information for a graphical session before the graphical session is started. Pre-initializing display information can reduce the time required to initialize the session. The list of standard supported resolutions 124 can represent the resolutions for which the pre-initialization is performed. Further, one or more additional resolutions can be added to the list of standard supported resolutions 124, such as based on one or more attributes associated with a known client.

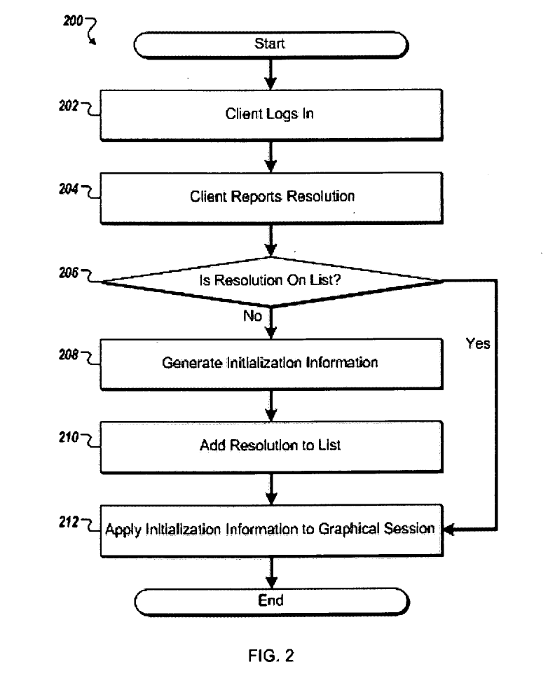

FIG. 2 shows a flow chart of an example process 200 for initializing a new graphical session associated with a remote client. A remote client can log in (202) to a system configured to host one or more graphical sessions to request initialization of a graphical session. Further, the client can report one or more supported display resolutions (204) to the host. For example, in the Remote Desktop Protocol (RDP), the remote client can announce to the host the client's currently configured display resolution. Alternatively, in a system using the Virtual Network Computing (VNC) protocol, the remote client can request a list of supported display resolutions from the host. The remote client can receive the list of supported display resolutions and can reply with a selected resolution. The reported or selected resolution can serve as the client's selected display resolution.

The host can determine whether the client's selected display resolution is on a list of initialized resolutions (206). If the selected resolution is on the list of initialized resolutions, the initialization information for that resolution can be applied to the graphical session (212) associated with the client. In some implementations, initialization information can include copies of one or more visual objects, such as fonts, windows, or graphical widgets that have been pre-rendered to display properly at a specific resolution. If the selected resolution is not on the list of initialized resolutions (206), initialization information corresponding to the selected resolution can be generated (208). Further, the client's selected resolution can be added to the list of initialized resolutions (210). Additionally, the initialization information for the selected resolution can be applied to the graphical session (212) associated with the client.

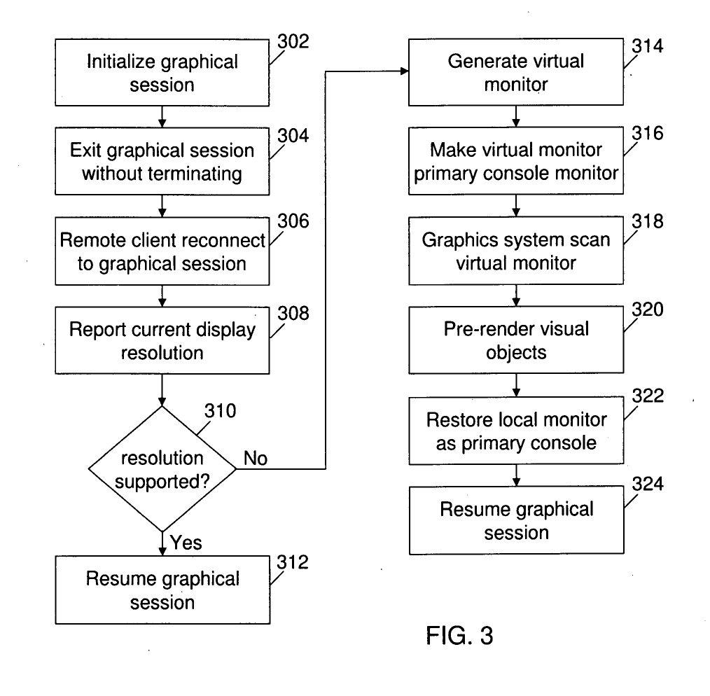

FIG. 3 shows an example process for a user reconnecting to an established graphical session. A remote client can initialize a graphical session, such as by transmitting a request to a host system (302). The graphical session can be initialized as described above with respect to FIG. 2. Further, a remote client can leave an established graphical session without terminating the session (304). For example, the client system can be shut down or disconnected from a communications network, or the window in which the graphical session is presented can be closed. The graphical session can remain active on the host while no client is interacting with the graphical session. In some implementations, the graphical session can be closed after a predetermined period of inactivity. Subsequently, the remote client can reconnect to the established graphical session (306). Upon reconnecting, the remote client can report the currently configured display resolution (308). The display resolution can be reported whether or not the resolution has changed. The host system can determine whether the currently configured display resolution is a supported resolution (310).

If the currently configured display resolution is included in the list of standard supported resolutions, including any custom resolutions that have been added, the graphical session can resume and display information for the graphical session is generated at the currently configured display resolution (312). Thus, a user can leave a graphical session initiated from a first remote client, such as an office computer, and then resume the graphical session from a second remote client, such as a home computer. The user also can leave a graphical session initiated from a first remote location and resume the graphical session from a second remote location, using the same computing device, such as a laptop.

If the currently configured display resolution reported by the remote client is not included in the list of standard supported resolutions, including any custom resolutions that have been added, a virtual monitor can be generated (314). The virtual monitor can be generated by the host system or a terminal server application, such as in response to a request to reestablish a remote graphical session. The virtual monitor can be configured to have a display resolution equal to the currently configured display resolution of the remote client. Once generated, the virtual monitor is identified as the primary console monitor (316). Thus, the local monitor physically connected to the host system is temporarily replaced by the virtual monitor. The graphics processing of the host system then can detect and scan the new primary console monitor, which is the virtual monitor (318). When the virtual monitor is scanned, the host system can determine its resolution and one or more visual objects, such as fonts, windows, or graphical widgets can be pre-rendered to display properly at the resolution of the virtual monitor (320). After the scan, the local monitor can be restored as the primary console monitor (322). Additionally, the graphical session can be resumed at the new resolution and the virtual monitor can be discarded (324).

In some implementations, the resolution of the primary console monitor can be changed to correspond to the currently configured display resolution reported by the remote client instead of generating a virtual monitor. Once the graphics processing of the host system has scanned the primary console monitor to determine its resolution and the one or more visual objects have been pre-rendered, the original resolution of the primary monitor can be restored and the graphical session associated with the remote client can be resumed at the new resolution.

In some other implementations, the graphical display associated with the remote system (i.e., the display information associated with the remote graphical session) can be set as the primary console monitor. The graphics processing of the host system can then scan the new primary console monitor to determine the selected resolution. Further, one or more visual objects can be pre-rendered at the resolution of the remote system graphical display. Once the visual objects have been pre-rendered, the local monitor corresponding to the host system can be reestablished as the primary console monitor and the graphical session associated with the remote client can be resumed at the new resolution.

In some other implementations, the request to reestablish the current graphical session at an unsupported resolution can be detected by the host system. The host system can then save the system state associated with the graphical session, such as in a buffer or system settings file, and the graphical session can be terminated. A new graphical session then can be established with the remote client, which can report the currently configured display resolution to the host system. The host system can pre-render one or more visual objects for use with the new graphical session. Further, the new graphical session can be restored to the state of the previous graphical session in accordance with the saved system state information.

The embodiments described above are given as illustrative examples only. It will be readily appreciated by those skilled in the art that many deviations may be made from the specific embodiments; accordingly, the scope of the invention is to be determined by the claims below rather than being limited to the specifically described embodiments above. In addition, the flowcharts found in the figures are provided to instruct a programmer of ordinary skill to write and debug the disclosed embodiments without undue effort; the logic flow may include other steps and the system other components. The invention is not limited to a particular expression of source or object code. Accordingly, other implementations are within the scope of the claims.

What is claimed:

1. A method of configuring display resolution in a terminal server environment, the method comprising:
receiving, by a host system, information from a remote client identifying a configured display resolution, wherein the remote client has requested a graphical session;
determining that the configured display resolution is not a standard supported resolution;
generating display initialization information corresponding to the configured display resolution; and
applying the display initialization information to the requested graphical session prior to transmission from the host system to the remote client.

2. The method of claim 1 wherein generating display initialization information comprises:
configuring a virtual monitor and
scanning the virtual monitor.

3. The method of claim 2 wherein the virtual monitor is a software driver.

4. The method of claim 2 further comprising:
identifying a primary console monitor as the virtual monitor;
scanning the virtual monitor; and
pre-rendering one or more visual objects to display properly at the resolution of the virtual monitor.

5. The method of claim 1 further comprising:
maintaining, for a predetermined period of inactivity from the remote client, the established graphical session without terminating;
receiving a request from the remote client to reconnect to the established graphical session, including information identifying a newly-reported configured display resolution;
determining that the newly-reported configured display resolution is not (i) a standard supported resolution or (ii) the previously-reported configured display resolution;
generating display initialization information corresponding to the newly-reported configured display resolution; and
applying the display initialization information to the requested graphical session prior to transmission from the host system to the remote client.

6. The method of claim 1, further comprising:
saving information associated with the system state of the graphical session, including the configured display resolution;
terminating the graphical session;
detecting a request from the remote client to establish a new graphical session; and
applying the display initialization information associated with the saved system state to the requested new graphical session.

7. The method of claim 1, further comprising adding the non-standard configured display resolution identified by the remote client to a group of custom display resolutions supported by the host system.

8. The method of claim 7, further comprising:
receiving, by the host system, a request from a second remote client to establish a graphical session, wherein the remote client identifies a configured display resolution;
determining that the configured display resolution is among the group of custom display resolutions supported by the host system;
applying pre-rendered, resolution-specific display initialization information to the requested graphical session prior to transmission from the host system to the second remote client.

9. A computer network system comprising:
a network host server comprising one or more processing elements, and one or more memory elements, wherein the server is in connection with one or more remote devices;
wherein the one or more processing elements are programmed or adapted to perform the steps comprising:
receiving information from a remote client identifying a configured display resolution, wherein the remote client has requested a graphical session;
determining that the configured display resolution is not a standard supported resolution;
generating display initialization information corresponding to the configured display resolution; and
applying the display initialization information to the requested graphical session prior to transmission the remote client.

10. The system of claim 9, further comprising one or more processing elements programmed or adapted to perform the steps comprising:
configuring a virtual monitor;
scanning the virtual monitor; and
pre-rendering one or more visual objects to display properly at the resolution of the virtual monitor.

11. The system of claim 9, further comprising one or more processing elements programmed or adapted to perform the steps comprising:
maintaining, for a predetermined period of inactivity from the remote client, the established graphical session without terminating;
receiving a request from the remote client to reconnect to the established graphical session, including information identifying a newly-reported configured display resolution;
determining that the newly-reported configured display resolution is not (i) a standard supported resolution or (ii) the previously-reported configured display resolution;
generating display initialization information corresponding to the newly-reported configured display resolution; and
applying the display initialization information to the requested graphical session prior to transmission from the host system to the remote client.

12. The system of claim 9, further comprising one or more processing elements programmed or adapted to perform the steps comprising:
saving information associated with the system state of the graphical session, including the configured display resolution;
terminating the graphical session;
detecting a request from the remote client to establish a new graphical session; and
applying the display initialization information associated with the saved system state to the requested new graphical session.

13. The system of claim 9, further comprising one or more processing elements programmed or adapted to perform adding the non-standard configured display resolution identified by the remote client to a group of custom display resolutions supported by the host system.

14. The system of claim 13, further comprising one or more processing elements programmed or adapted to perform the steps comprising:
receiving a request from a second remote client to establish a graphical session, wherein the remote client identifies a configured display resolution;
determining that the configured display resolution is among the group of custom display resolutions supported by the host system;
applying pre-rendered, resolution-specific display initialization information to the requested graphical session prior to transmission from the host system to the second remote client.

15. A tangible computer-readable storage media comprising stored instructions that, upon execution by a programmable processor, are operable to cause the programmable processor to perform the method of claim 1.
